(19) United States
(12) Patent Application Publication
(10) Pub. No.: US 2026/0235894 A1
(43) Pub. Date: Aug. 13, 2026

(54) OPTICAL PHASE MODULATOR, OPTICAL CIRCUIT, MACH-ZEHNDER INTERFEROMETER, AND OPTICAL ACCELERATOR

(71) Applicants: THE UNIVERSITY OF OSAKA, Osaka (JP); NICHIA CORPORATION, Anan-shi (JP)

(72) Inventors: Tomoyuki TANIKAWA, Suita-shi (JP); Ryuji KATAYAMA, Suita-shi (JP); Masahiro UEMUKAI, Suita-shi (JP); Ryuki SUGANO, Suita-shi (JP); Masanori OKADA, Yokohama-shi (JP)

(73) Assignees: THE UNIVERSITY OF OSAKA, Osaka (JP); NICHIA CORPORATION, Anan-shi (JP)

(21) Appl. No.: 19/530,938

(22) Filed: Feb. 5, 2026

(30) Foreign Application Priority Data
Feb. 7, 2025 (JP) 2025-019410
Jan. 29, 2026 (JP) 2026-013341

(51) Int. Cl. G02F 1/015; G02F 1/21

(52) U.S. Cl. CPC G02F 1/0154; G02F 1/212; G02F 2201/063; G02F 2202/06; G02F 2202/10

(57) ABSTRACT

An optical phase modulator includes: a first optical waveguide including: a first cladding layer, a core layer disposed above the first cladding layer, and a second cladding layer disposed above the core layer; a first electrode electrically connected to the first cladding layer; and a second electrode electrically connected to the second cladding layer, wherein: the first cladding layer comprises a first compound semiconductor layer of a first conductivity type, the second cladding layer comprises a second compound semiconductor layer of a second conductivity type, the core layer comprises a third compound semiconductor layer having a carrier density determined from a C-V characteristic of 1×10¹⁷ cm⁻³ or less, and at least one of the first compound semiconductor layer and the second compound semiconductor layer comprises a composition gradient layer.

### CROSS REFERENCE TO RELATED APPLICATION

This application claims priority to Japanese Patent Applications No. 2025-019410, filed on Feb. 7, 2025, and Japanese Patent Applications No. 2026-013341, filed on Jan. 29, 2026. The entire contents of these applications are hereby incorporated by reference.

### TECHNICAL FIELD

The present disclosure relates to an optical phase modulator, an optical circuit, a Mach-Zehnder interferometer, and an optical accelerator.

### BACKGROUND

Non-Patent Document 1 (Takuya Kamei and 4 others, “Structural Investigation and Fabrication of GaN Optical Waveguide Electric-Field Driven Mach-Zehnder Interferometer”, Proceedings of the 70 Spring Meeting of the Japan Society of Applied Physics, 2023, Japan Society of Applied Physics, Feb. 27, 2023, 15p-B401-17) discloses that a Mach-Zehnder interferometer using an optical phase modulator including an optical waveguide formed of a GaN layer is connected in multiple stages to constitute an optical AI accelerator. It is expected that an optical AI accelerator can perform calculations at high speed and with low power consumption as compared with an electronic circuit. The optical phase modulator can change a refractive index of an optical waveguide by applying a potential to the optical waveguide by a metal electrode disposed on the optical waveguide. To suppress absorption of guided light passing through the optical waveguide by the metal electrode, a SiO₂ film is disposed between the optical waveguide and the metal electrode to improve optical confinement.

The optical phase modulator disclosed in Non-Patent Document 1 has a so-called metal-oxide-semiconductor (MOS) diode structure in which a SiO₂ film is disposed between a GaN layer constituting an optical waveguide and a metal electrode. Electrical characteristics of the optical phase modulator are affected by interface trap charges generated at an interface between the semiconductor and the oxide. Therefore, there is a disadvantage that the half-wavelength voltage tends to increase.

### SUMMARY

An object of the present disclosure is to provide an optical phase modulator, an optical circuit, a Mach-Zehnder interferometer, and an optical accelerator which are good in optical confinement and electrical characteristics.

An optical phase modulator according to an embodiment of the present invention comprises:
a first optical waveguide comprising a first cladding layer, a core layer disposed above the first cladding layer, and a second cladding layer disposed above the core layer;
a first electrode electrically connected to the first cladding layer; and
a second electrode electrically connected to the second cladding layer, wherein
the first cladding layer comprises a first compound semiconductor layer of a first conductivity type,
the second cladding layer comprises a second compound semiconductor layer of a second conductivity type,
the core layer comprises a third compound semiconductor layer having a carrier density determined from a C-V characteristic of 1×10¹⁷ cm⁻³ or less, and
at least one of the first compound semiconductor layer and the second compound semiconductor layer comprises a composition gradient layer.

An optical phase modulator according to another embodiment of the present invention comprises:
a first optical waveguide comprising a first cladding layer, a core layer disposed above the first cladding layer, and a second cladding layer disposed above the core layer;
a first electrode electrically connected to the first cladding layer; and
a second electrode electrically connected to the second cladding layer, wherein
the first cladding layer comprises a first compound semiconductor layer of a first conductivity type,
the second cladding layer comprises a second compound semiconductor layer of a second conductivity type,
the core layer comprises a third compound semiconductor layer having a first conductivity type impurity concentration lower than that of the first compound semiconductor layer, and
at least one of the first compound semiconductor layer and the second compound semiconductor layer comprises a composition gradient layer.

An optical circuit according to an embodiment of the present invention comprises:
the optical phase modulator according to any one of the above embodiments; and
a second optical waveguide that optically couples with the optical phase modulator.

A Mach-Zehnder interferometer according to an embodiment of the present invention comprises:
the optical circuit;
a third optical waveguide disposed in parallel with the optical circuit;
an input port for receiving light; and an output port for outputting the light.

An optical accelerator according to an embodiment of the present invention comprises:
the Mach-Zehnder interferometer;
a light source that inputs light to an input port of the Mach-Zehnder interferometer; and
a light receiving element that receives light output from an output port of the Mach-Zehnder interferometer.

According to the embodiments of the present disclosure, it is possible to provide an optical phase modulator, an optical circuit, a Mach-Zehnder interferometer, and an optical accelerator which have good optical confinement and good electrical characteristics.

### BRIEF DESCRIPTION OF DRAWINGS

FIG. 1 is a schematic perspective view illustrating an example of an optical circuit including an optical phase modulator;

FIG. 2 is a schematic cross-sectional view taken along line II-II in FIG. 1, and illustrates an example of the optical phase modulator;

FIG. 3 is a schematic cross-sectional view illustrating another example of the optical phase modulator;

FIG. 4 is a schematic cross-sectional view illustrating still another example of the optical phase modulator;

FIG. 5 is a schematic cross-sectional view illustrating still another example of the optical phase modulator;

FIG. 6 is a schematic top view of a linear waveguide that is an example of a first optical waveguide included in the optical phase modulator;

FIG. 7 is a schematic top view of a bending waveguide which is an example of the first optical waveguide included in the optical phase modulator;

FIG. 8 is a schematic top view of a ring resonator which is an example of the first optical waveguide included in the optical phase modulator;

FIG. 9 is an optical circuit using a first optical waveguide including a linear waveguide;

FIG. 10 illustrates an optical circuit using a first optical waveguide including a bending waveguide;

FIG. 11 illustrates an optical circuit using a first optical waveguide including a ring resonator;

FIG. 12 is a schematic cross-sectional view taken along line XII-XII of FIG. 11, and illustrates an example of an optical circuit;

FIG. 13 is a schematic perspective view of a Mach-Zehnder interferometer;

FIG. 14 is a schematic cross-sectional view taken along line XIV-XIV in FIG. 13, and illustrates an example of a third optical waveguide;

FIG. 15 is a schematic cross-sectional view illustrating another example of the third optical waveguide; and

FIG. 16 is a schematic perspective view of an optical accelerator.

### DETAILED DESCRIPTION

Hereinafter, embodiments of an optical phase modulator, an optical circuit, a Mach-Zehnder interferometer, and an optical accelerator according to the present invention will be described. Note that, because the drawings referred to in the following description schematically illustrate embodiments of the present invention, scales, intervals, positional relationships, and the like of the respective members may be exaggerated, or illustration of a part of the members may be omitted. In addition, scales and intervals of the members may not match between the top view and the cross-sectional view. In the following description, the same names and reference numerals indicate the same or similar members in principle, and repeated detailed description of such members will be appropriately omitted.

In the present specification, “upper,” “above,” “lower,” “below,” and the like indicate relative positions between components in the drawings referred to for description, and are not intended to indicate absolute positions unless otherwise specified.

### First Embodiment: Optical Phase Modulator

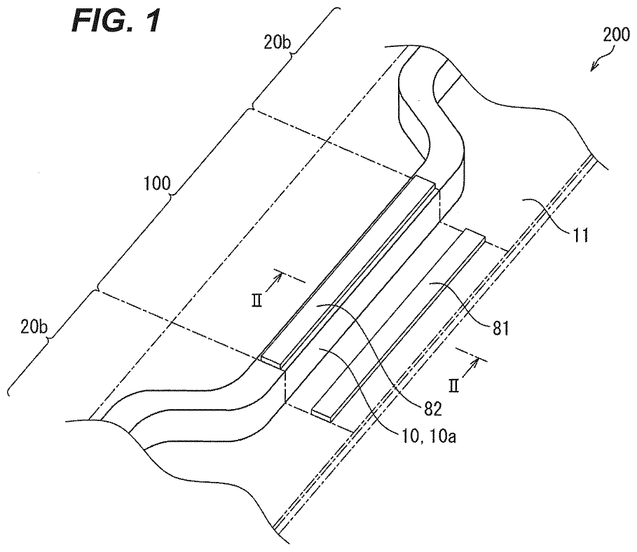

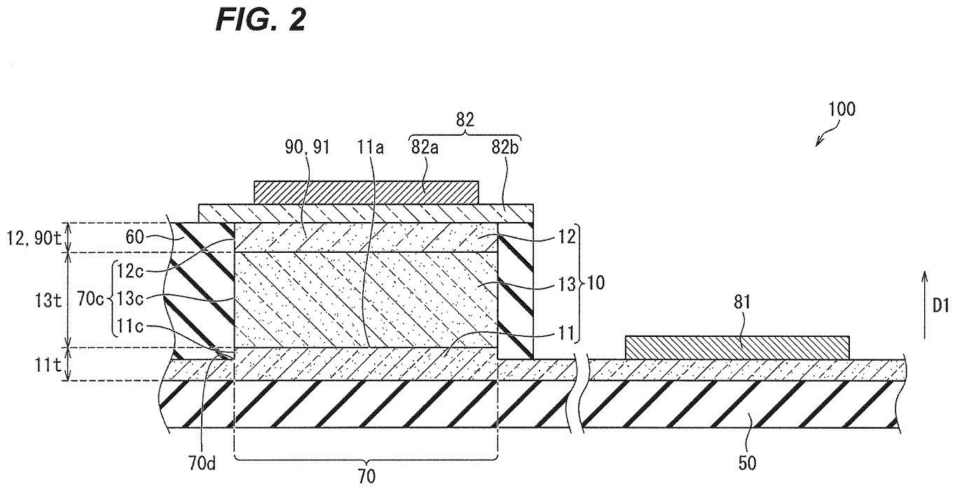

FIG. 1 is a schematic perspective view illustrating an example of an optical circuit 200 including an optical phase modulator 100 according to a first embodiment. FIG. 2 is a schematic cross-sectional view taken along line II-II in FIG. 1.

The optical phase modulator 100 includes a first optical waveguide 10, a first electrode 81, and a second electrode 82. The first optical waveguide 10 is formed by stacking a first cladding layer 11, a core layer 13 disposed above the first cladding layer 11, and a second cladding layer 12 disposed above the core layer 13. The first electrode 81 is electrically connected to the first cladding layer 11, and the second electrode 82 is electrically connected to the second cladding layer 12. The optical phase modulator 100 can change the phase of the light passing through the first optical waveguide 10 by applying a voltage between the first electrode 81 and the second electrode 82 to change the refractive index of the core layer 13.

The first cladding layer 11 includes a first compound semiconductor layer of a first conductivity type. The second cladding layer 12 includes a second compound semiconductor layer of a second conductivity type. The core layer 13 includes a third compound semiconductor layer having a carrier density of 1×10¹⁷ cm⁻³ or less, which is obtained from the C-V characteristic.

At least one of the first compound semiconductor layer and the second compound semiconductor layer includes a composition gradient layer 90.

The composition gradient layer 90 is a layer that causes polarization by changing the composition of constituent elements contained in the first compound semiconductor layer or the second compound semiconductor layer in stages. In the composition gradient layer 90, carrier doping, which is also called polarization doping, is performed. The first compound semiconductor layer or the second compound semiconductor layer including the composition gradient layer 90 can be a p-type or n-type semiconductor without containing an impurity dopant. Polarization doping utilizes carriers that are accumulated to counteract fixed charges resulting from ionic polarization, spontaneous polarization, and piezoelectric polarization of the semiconductor layer. Therefore, if the composition gradient layer 90 is formed so as to generate a negative fixed charge, positive carriers are accumulated, and the semiconductor layer can be made p-type. Similarly, when the composition gradient layer 90 is formed so as to generate a positive fixed charge, negative carriers are accumulated, and the semiconductor layer can be made n-type.

The composition of the composition gradient layer 90 may be changed continuously or stepwise. A specific configuration of the composition gradient layer (that is, the first composition gradient layer 91 and the second composition gradient layer 92) will be described later.

By including the composition gradient layer 90, the refractive index of the first compound semiconductor layer or the second compound semiconductor layer changes, so that optical confinement to the first optical waveguide 10 can be improved. As a result, an optical phase modulator can be configured without adopting a MOS diode structure as disclosed in Non-Patent Document 1. For example, when the second compound semiconductor layer of the second cladding layer 12 includes the first composition gradient layer 91, the SiO₂ layer between the first optical waveguide 10 and the second electrode 82 can be omitted, and the first optical waveguide 10 and the second electrode 82 can be electrically connected. As a result, as compared with the MOS diode of Non-Patent Document 1, it is possible to obtain the optical phase modulator 100 that is not affected by interface trapped charges at the interface between the semiconductor and the oxide interface. That is, because the optical phase modulator 100 of the present embodiment operates as a pin type diode, the half wavelength voltage is smaller than that of the MOS diode. In addition, in the MOS diode, a temporal drift of phase modulation derived from charging and discharging of interface trapped charges occurs, but in the optical phase modulator 100 of the present embodiment, such a temporal drift of phase modulation does not occur. From the viewpoint of optical confinement, optical confinement is improved even when the composition gradient layer 90 is either n-type or p-type. This is because the average refractive index of the composition gradient layer 90 is smaller than the refractive index of the core layer 13, and the composition gradient layer 90 functions as a cladding layer.

In an example of the optical phase modulator 100, the first conductivity type included in the first cladding layer 11 is n-type, and the second conductivity type included in the second cladding layer 12 is p-type. Then, the second compound semiconductor layer includes the first composition gradient layer 91, and the composition of the second compound semiconductor layer is gradated such that the band gap energy decreases in a first direction D1 toward the second cladding layer 12 with respect to the core layer 13. In other words, the composition of the first composition gradient layer 91 is gradated so as to increase the refractive index in the first direction D1. Because the first composition gradient layer 91 has a smaller refractive index as it is closer to the core layer 13, it is possible to enhance optical confinement to the core layer 13. Because the first composition gradient layer 91 is included in the second compound semiconductor layer and the second compound semiconductor layer is included in the second cladding layer 12, optical confinement by the second cladding layer 12 is improved, and guided light reaching the second electrode 82 can be reduced. In addition, when the p-type semiconductor is a p-type nitride semiconductor containing a p-type impurity, it is difficult to form the p-type nitride semiconductor thick because there is a possibility of crystallinity degradation. However, because optical confinement can be improved by the first composition gradient layer 91, an optical confinement effect can be exhibited even if the p-type nitride semiconductor is relatively thin.

The third compound semiconductor layer included in the core layer 13 has a carrier density of 1×10¹⁷ cm⁻³ or less. The carrier density of the third compound semiconductor layer included in core layer 13 is preferably 5×10¹⁶ cm⁻³ or less, 1×10¹⁶ cm⁻³ or less, or 5×10¹⁵ cm⁻³ or less. Because the carrier density is low, the third compound semiconductor layer can be regarded as a so-called substantially i-type semiconductor (true semiconductor). That is, in the optical phase modulator 100 according to first embodiment, the first optical waveguide 10 has a layer configuration similar to that of the pin diode. Therefore, by applying a reverse bias between the first electrode 81 and the second electrode 82, it is possible to perform optical phase modulation while suppressing current flow due to the rectification effect of the diode and reducing power consumption. In the present specification, the “i-type semiconductor” also includes an undoped semiconductor layer that is not intentionally doped with impurities.

The carrier density of the third compound semiconductor layer is determined from the following formula.

$$[ Math . 1 ]$$

$$C ∼ S \sqrt{\frac{q ϵ N}{2 ( {φ}_{bi} - {V}_{B} )}}$$

Here, each character is defined as follows:
C: Electric capacitance
V_{B}: Reverse bias
ε: Dielectric constant of core layer 13
S: Area of depletion layer
N: Carrier density
φ_{bi}: Built-in potential
q: Elementary charge

In the above formula, each variable can be estimated as follows.

The dielectric constant F of the core layer 13 can be determined from publicly-known data based on the material constituting the core layer 13.

The area S of the depletion layer substantially matches the area of the second electrode 82 in top view.

The built-in potential φ_{bi} can be obtained from the V intercept of the C⁻²-V characteristic.

The electric capacitance C is measured while changing the reverse bias V_{B} at a high frequency (1 MHz). In a graph in which the horizontal axis is plotted as the reverse bias V_{B} and the vertical axis is plotted as the electric capacitance C⁻², the carrier density can be obtained from the slope of the graph in a region where C⁻² is proportional to the reverse bias.

It is preferable that the first optical waveguide 10 includes a ridge 70 including a first cladding layer 11, a core layer 13, and a second cladding layer 12. It is preferable that a lower end 70d of a lateral surface 70c of the ridge 70 is located below an interface 11a between the core layer 13 and the first cladding layer 11. This can confine the light within the ridge 70 and reduces light leakage of the guided light in the lateral direction, which can facilitate good optical confinement. Note that the “lateral direction” refers to a direction orthogonal to the longitudinal direction (optical axis direction) of the first optical waveguide 10 in top view.

As described above, the optical phase modulator 100 is an element that changes the phase of light passing through the first optical waveguide 10 by applying a voltage between the first electrode 81 and the second electrode 82 to change the refractive index of the core layer 13. Therefore, because the optical phase modulator 100 itself does not emit light, a quantum well structure that forms light-emitting recombination is unnecessary in the core layer 13.

There is a semiconductor laser element having a quantum well structure and a composition gradient layer. For example, a general semiconductor laser element often forms an optical waveguide by providing a ridge on a part of a p-side semiconductor layer formed on an upper side of an active layer. In this case, optical confinement in the lateral direction is relatively weak.

In top view, the width in the direction perpendicular to the longitudinal direction (optical axis) of the first optical waveguide 10 may be 10 μm or less. That is, the dimension of the ridge 70 in the lateral direction may be 10 μm or less. Because the first optical waveguide 10 can be reduced in size, the optical phase modulator 100 can be downsized. It is preferable that the dimension of the ridge 70 in the lateral direction is 5 μm or less, 3 μm or less, or 1 μm or less. As a result, it is possible to cut off the higher-order mode and limit the guided light to the lateral single mode. It is preferable that the phase modulation is performed in the lateral single mode. Furthermore, because the width in the lateral direction is relatively small and the area of the optical phase modulator 100 in top view can be reduced, the electric capacitance of the optical phase modulator 100 can be reduced. A time constant defined by the CR product becomes small, and relatively faster phase modulation is possible. Here, the CR product is a product of the electric capacitance C and the electric resistance R of the optical phase modulator 100.

Because the lower end 70d of the ridge 70 of the optical phase modulator 100 is located deeper than the lower end of the ridge of a general semiconductor laser element, optical confinement in the lateral direction is stronger than that of a general semiconductor laser element, which is advantageous for phase modulation. In addition, as will be described later, the optical phase modulator 100 has a small bending loss, and is advantageous in forming a Mach-Zehnder interferometer or the like.

It is preferable that the optical phase modulator 100 further includes an insulating layer 60 covering a lateral surface 11c of the first cladding layer 11, a lateral surface 13c of the core layer 13, and a lateral surface 12c of the second cladding layer 12. As a result, the loss due to the refractive index difference can be reduced as compared with the case where the lateral direction is the air layer. In addition, because the lateral surface of each layer is covered, the lateral surface of each layer is protected from the external environment, and thus, for example, the probability of occurrence of an unintended leakage current path due to adhesion of foreign matter can be reduced. The lateral surfaces 11c, 13c, and 12c constitute the lateral surface 70c of the ridge 70. The insulating layer 60 may be, for example, aluminum oxide, silicon oxide, aluminum nitride, silicon nitride, or the like.

It is preferable that the first compound semiconductor layer, the second compound semiconductor layer, and the third compound semiconductor layer contain nitrogen in composition. That is, the first compound semiconductor layer, the second compound semiconductor layer, and the third compound semiconductor layer are nitride semiconductors.

Because the nitride semiconductor has high transmittance with respect to visible light, an optical phase modulator having a relatively small loss with respect to visible light can be obtained by the optical phase modulator 100. In addition, because the nitride semiconductor is resistant to dielectric breakdown, it is possible to obtain the optical phase modulator 100 that is less prone to failure even when the reverse bias V_{B} is applied at the time of driving the optical phase modulator 100.

The first compound semiconductor layer can contain AlₓGa₁₋ₓN (0≤x<1) containing an n-type impurity, the second compound semiconductor layer may contain Al_{y}Ga_{1-y}N (0≤y<1), and the third compound semiconductor layer may contain Al_{z}Ga_{1-z}N (0≤z<1, z≤x, z≤y).

When the second compound semiconductor layer has the above composition, in the first composition gradient layer 91, the Al composition ratio y of the second compound semiconductor layer decreases in the first direction D1. The first composition gradient layer 91 can be made p-type by polarization doping, and light can be confined in the core layer 13.

When the Al composition y of the first composition gradient layer 91 takes the smallest value, the Al composition y of the second compound semiconductor layer and the Al composition z of the third compound semiconductor layer may be the same.

It is preferable that the first composition gradient layer 91 has a thickness of 10 nm or more and 500 nm or less, and the Al composition ratio y of the second compound semiconductor layer decreases at a rate of 0.001 or more and 0.02 or less per 1 nm in the first direction, and optical confinement of the second cladding layer 12 can be further improved.

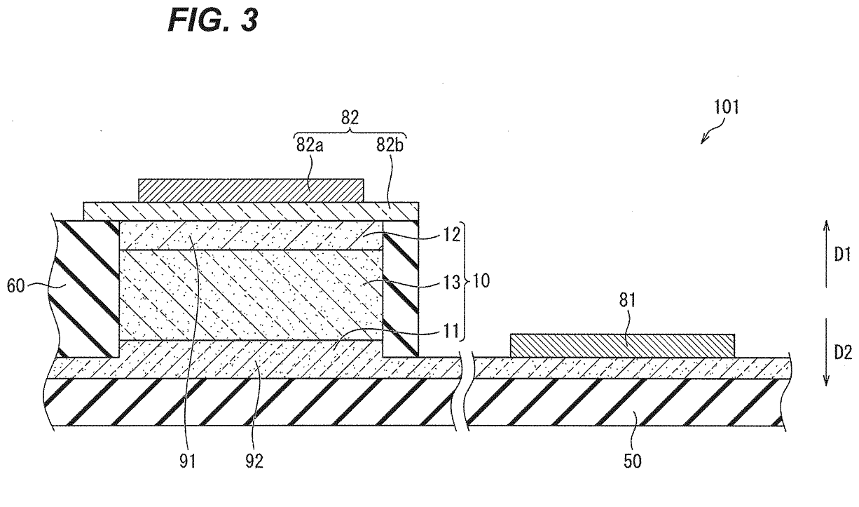

As illustrated in FIG. 3, the optical phase modulator 101 can include a first composition gradient layer 91 in the second compound semiconductor layer and a second composition gradient layer 92 in the first compound semiconductor layer. This can also improve optical confinement to the core layer 13 by the first cladding layer 11 including the first compound semiconductor layer. When the Al composition x of the second composition gradient layer 92 takes the smallest value, the Al composition x of the first compound semiconductor layer and the Al composition z of the third compound semiconductor layer may be the same.

In the second composition gradient layer 92, it is preferable that the composition is gradated such that the band gap energy decreases in a second direction D2 toward the first cladding layer 11 with respect to the core layer 13. In other words, in the second composition gradient layer 92, it is preferable that the composition of the first compound semiconductor layer is gradated such that the refractive index increases in the second direction D2. The second composition gradient layer 92 has a smaller refractive index as it is closer to the core layer 13, so that optical confinement to the core layer 13 can be enhanced. Because the second composition gradient layer 92 is included in the first compound semiconductor layer and the first compound semiconductor layer is included in the first cladding layer 11, optical confinement to the core layer 13 by the first cladding layer 11 is improved.

Because the first compound semiconductor layer includes the second composition gradient layer 92, the first compound semiconductor layer can be an n-type semiconductor without containing an n-type impurity. When the first compound semiconductor layer does not contain an n-type impurity, the crystallinity of the first cladding layer 11 can be improved, so that the crystallinity of the core layer 13 and the second cladding layer 12 disposed above the first cladding layer 11 can also be improved. However, the present invention is not limited to this example, and the first compound semiconductor layer may be an n-type semiconductor containing an n-type impurity. Further, the second composition gradient layer 92 may be provided in a part of the first compound semiconductor layer, and polarization doping may be performed. The second composition gradient layer 92 is disposed so as to be in contact with the core layer 13. As a result, a range close to the guided light can be made to have a high carrier density while being undoped in the composition gradient layer, and a pin diode structure in which electrical connection with the first electrode 81 is easily taken is obtained.

By grading the composition along the first direction D1, the first composition gradient layer 91 becomes polarization doping and can function as a p-type semiconductor without containing a p-type impurity, but may contain a small amount of p-type impurity to further improve the function as a p-type semiconductor. The density of the p-type impurity may be, for example, 1×10¹⁶ cm⁻³ or more and 1×10²⁰ cm⁻³ or less.

Similarly, by grading the composition along the second direction D2, the second composition gradient layer 92 can function as an n-type semiconductor without containing an n-type impurity, but may contain an n-type impurity to further improve the function as an n-type semiconductor. The density of the n-type impurity may be, for example, 1×10¹⁶ cm⁻³ or more and 1×10²⁰ cm⁻³ or less.

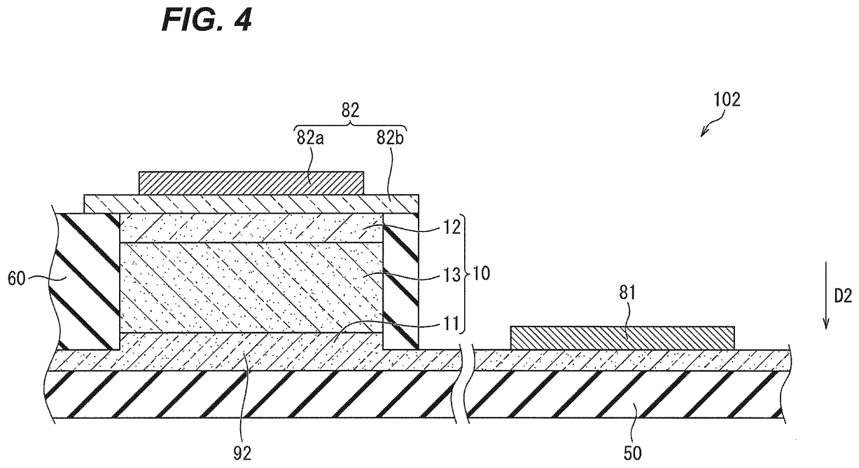

As in the optical phase modulator 102 illustrated in FIG. 4, the second compound semiconductor layer may not include the first composition gradient layer 91, and the first compound semiconductor layer may include the second composition gradient layer 92. In that case, it is preferable that the first compound semiconductor layer contains Al_{y}Ga_{1-y}N (0≤y<1), the second compound semiconductor layer contains AlₓGa₁₋ₓN doped with a p-type impurity (0≤x<1), and the third compound semiconductor layer contains Al_{z}Ga_{1-z}N (0≤z<1, z≤x, z≤y).

It is preferable that the second composition gradient layer has a thickness of 100 nm or more and 500 nm or less, and the Al composition ratio x of the first compound semiconductor layer decreases at a rate of 0.01 or more and 0.02 or less per 1 nm in the second direction, so that optical confinement of the first cladding layer 11 can be further improved.

In the optical phase modulators 100, 101, and 102 illustrated in FIGS. 2 to 4, the first conductivity type included in the first cladding layer 11 may be p-type, and the second conductivity type included in the second cladding layer 12 may be n-type. In this case, the first compound semiconductor layer includes the second composition gradient layer 92, and the composition of the first compound semiconductor layer is gradated such that the band gap energy increases in the second direction D2 toward the first cladding layer 11 with respect to the core layer 13. In other words, the second composition gradient layer 92 is formed so that the refractive index decreases in the second direction D2. By using the first compound semiconductor layer as the second composition gradient layer 92, a p-type nitride semiconductor can be obtained without using a p-type impurity. As a result, the crystallinity of the first cladding layer 11 is improved, and the crystallinity of the core layer 13 and the second cladding layer 12 stacked thereabove can also be improved. In particular, when the first compound semiconductor layer is a p-type nitride semiconductor, the crystallinity is easily deteriorated by containing a p-type impurity, and thus the second composition gradient layer 92 can reduce the content of the p-type impurity and improve the crystallinity of the p-type nitride semiconductor.

In the optical phase modulator 100, a substrate such as sapphire, gallium nitride, silicon carbide, or aluminum nitride may be further disposed below the first cladding layer. As illustrated in FIG. 2, it is preferable that the optical phase modulator 100 includes a sapphire substrate 50 below the first cladding layer 11. Because the sapphire substrate 50 has a relatively low refractive index, the optical confinement of the first optical waveguide 10 can be further improved. When the first compound semiconductor layer, the second compound semiconductor layer, and the third compound semiconductor layer are nitride semiconductor layers, the sapphire substrate 50 can also be used as a growth substrate of the first cladding layer 11, the core layer 13, and the second cladding layer 12 of the first optical waveguide 10.

When the first compound semiconductor layer and the third compound semiconductor layer have the same composition, the sapphire substrate 50 can be regarded as a part of the first cladding layer 11.

The first electrode 81 is formed in a portion where the first cladding layer 11 is exposed at a position away from the ridge 70. The first electrode 81 is, for example, a metal electrode.

The second electrode 82 is formed above the ridge 70, and can include a light-transmissive conductive film 82b covering the upper surface of the second cladding layer 12 and a metal electrode 82a formed on the upper surface of the light-transmissive conductive film 82b. The light-transmissive conductive film 82b has a smaller refractive index than the core layer 13. Therefore, the light-transmissive conductive film 82b can also function as a cladding layer. The light-transmissive conductive film 82b may be, for example, an indium tin oxide (ITO) film.

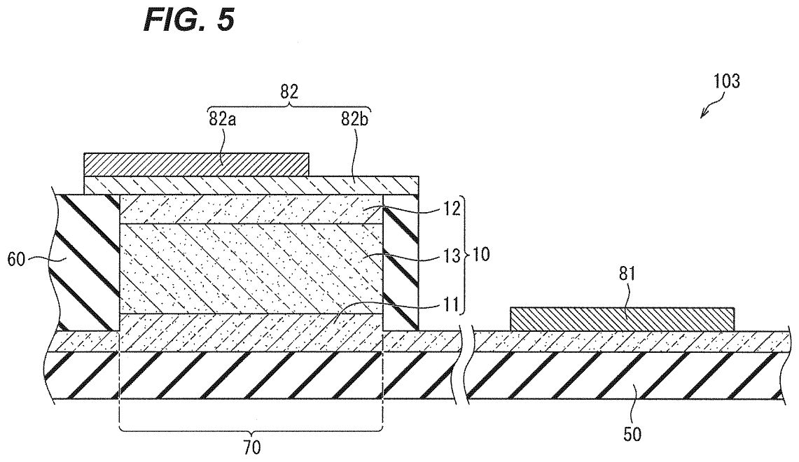

As illustrated in FIGS. 2 to 4, the metal electrode 82a may be disposed so as to completely overlap the ridge 70 in top view, or as illustrated in FIG. 5, the metal electrode 82a may be disposed so as to partially overlap the ridge 70 in top view. Furthermore, the metal electrode 82a may be disposed so as not to overlap the ridge 70 in top view. In either case, the second cladding layer 12 included in the ridge 70 can be electrically connected via the light-transmissive conductive film 82b.

A thickness 13t of the core layer 13 is preferably 0.5 times or more and 5 times or less a thickness 11t of the first cladding layer 11 and a thickness 12t of the second cladding layer 12. As a result, the performance of optical confinement to the optical waveguide can be sufficiently exhibited. For example, when the light guided through the core layer 13 is red light or infrared light, the thickness 13t of the core layer 13 is preferably 500 nm or more and 1500 μm or less. As a result, the performance of optical confinement to the waveguide can be sufficiently exhibited.

Similarly, when light guided through the core layer 13 is blue light or green light, the thickness 13t of the core layer 13 is preferably 300 nm or more and 900 nm or less. For example, when light guided through the core layer 13 is ultraviolet light or violet light, the thickness 13t of the core layer 13 is preferably 200 nm or more and 600 nm or less. In the present specification, the infrared light is light having a peak wavelength of 700 nm or more and 1100 nm or less. The red light is light having a peak wavelength of 600 nm or more and less than 700 nm. The green light is light having a peak wavelength of 500 nm or more and 550 nm or less. The blue light is light having a peak wavelength of 420 nm or more and less than 500 nm.

The violet light is light having a peak wavelength of 370 nm or more and 400 nm or less. The ultraviolet light is light having a peak wavelength of 320 nm or more and less than 370 nm.

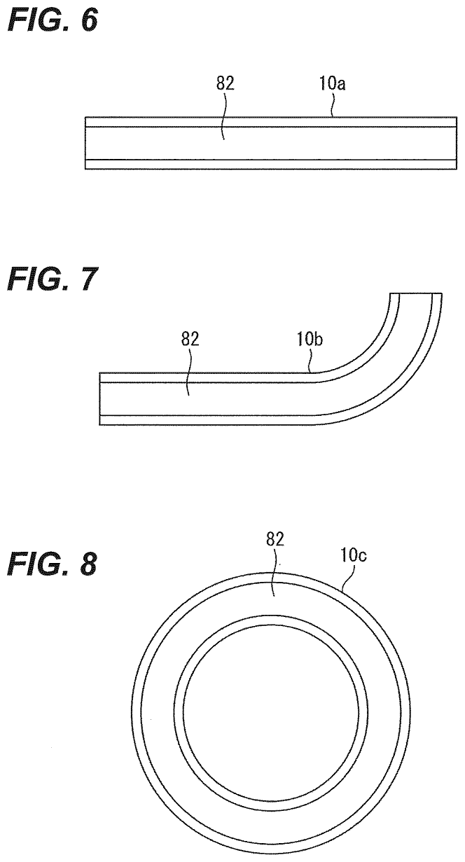

The first optical waveguide 10 can have various shapes in top view. Examples thereof include a linear waveguide 10a as illustrated in FIG. 6, a bending waveguide 10b as illustrated in FIG. 7, and a ring resonator 10c as illustrated in FIG. 8.

The linear waveguide 10a is a linear shape in the longitudinal direction. The bending waveguide 10b is at least partially curved, and the curvature of the curved portion may be constant like an arc or may change like a clothoid. The waveguide of the ring resonator 10c has a ring shape in top view. The top view shape of the ring resonator 10c is not limited to a circle, and is not limited as long as it is a closed loop such as an ellipse or a racetrack shape.

When the first optical waveguide 10 is the bending waveguide 10b and the ring resonator 10c, the bending radius of the first optical waveguide 10 is preferably 50 μm or more and 500 μm or less. Because the lower end 70d of the lateral surface 70c of the ridge 70 is located below the interface 11a between the core layer 13 and the first cladding layer 11, light is strongly confined in the lateral direction, and bending loss can be relatively reduced even when the bending radius is 50 μm or more. When the bending radius is 500 μm or less, the optical phase modulator can be downsized.

When the curvature changes in the bending waveguide 10b, the maximum curvature and the minimum curvature are preferably within a range of a bending radius of 50 μm or more and 500 μm or less.

A method for manufacturing the optical phase modulator 100 according to the first embodiment illustrated in FIG. 1 will be described. In the optical phase modulator 100, for example, the first cladding layer 11, the core layer 13, and the second cladding layer 12 may be formed by a metal organic chemical vapor deposition (MOCVD) method, and the first electrode 81 and the second electrode 82 may be formed by a physical vapor deposition method.

The composition gradient layer 90, 91, or 92 may be adjusted so as to obtain a desired composition gradient by appropriately adjusting the flow rate of the raw material gas. The flow rate of the raw material gas may be changed continuously or stepwise.

After each semiconductor layer is formed, a mask is formed. Before forming the mask, the light-transmissive conductive film 82b may be formed on the second cladding layer 12.

The semiconductor layer exposed from the mask is etched to obtain the first optical waveguide 10. The etching may be, for example, dry etching such as reactive ion etching.

Subsequently, the first optical waveguide 10 is embedded in an insulating layer 60 formed by a chemical vapor deposition method. The surface of the insulating layer 60 is planarized by polishing, and the first optical waveguide 10 or the light-transmissive conductive film 82b is exposed from the insulating layer 60 by reactive ion etching. An electrode is formed on each of the first optical waveguide 10 or the light-transmissive conductive film 82b exposed from the insulating layer 60 and the first cladding layer 11. Each electrode is patterned by lift-off.

### Second Embodiment: Optical Phase Modulator

An optical phase modulator according to the second embodiment has the same configuration as the optical phase modulator 100 according to first embodiment except for the third compound semiconductor layer included in the core layer 13. In the second embodiment, the impurity concentration of the first conductivity type of the third compound semiconductor layer included in the core layer 13 is lower than that of the first compound semiconductor layer.

The optical phase modulator according to the second embodiment will also be described with reference to FIG. 2.

The optical phase modulator 100 according to the second embodiment includes a first optical waveguide 10, a first electrode 81, and a second electrode 82. The first optical waveguide 10 is configured by stacking a first cladding layer 11, a core layer 13 disposed above the first cladding layer 11, and a second cladding layer 12 disposed above the core layer 13.

The first electrode 81 is electrically connected to the first cladding layer 11, and the second electrode 82 is electrically connected to the second cladding layer 12.

The first cladding layer 11 includes a first compound semiconductor layer of a first conductivity type, the second cladding layer 12 includes a second compound semiconductor layer of a second conductivity type, and the core layer 13 includes a third compound semiconductor layer. The impurity concentration of the first conductive impurity in the third compound semiconductor layer is lower than the impurity concentration of the first conductive impurity in the first compound semiconductor layer.

At least one of the first compound semiconductor layer and the second compound semiconductor layer includes a composition gradient layer 90.

The impurity concentrations of the first conductive impurities contained in the first compound semiconductor layer and the third compound semiconductor layer and the composition gradient layer 90 in the first compound semiconductor layer and the second compound semiconductor layer can be confirmed by analysis by transmission electron microscope-energy dispersive X-ray spectroscopy (cross-section TEM-EDX) in a cross section perpendicular to the longitudinal direction of the first optical waveguide 10.

For example, when the impurity element of the first conductivity type is Si and the element of the composition gradient in the composition gradient layer 90 is Al, element mapping of the cross section TEM-EDX in the cross section in the stack direction is performed to obtain a Si intensity map and an Al intensity map. By taking a line profile in the stacking direction from the Si intensity map, it can be confirmed that the Si concentration in the first compound semiconductor layer and the third compound semiconductor layer changes. By taking a line profile in the stacking direction from the Al intensity map, it is possible to confirm whether or not the first compound semiconductor layer and the second compound semiconductor layer include the composition gradient layer 90 whose composition is gradated in the stacking direction.

The concentration of the first conductive impurity contained in the third compound semiconductor layer may be equal to or less than the detection limit value in the analysis by energy dispersive X-ray spectroscopy (EDX) in a region including the interface between the first compound semiconductor layer and the third compound semiconductor layer.

The detection limit for EDX is generally 1500 ppm to 2000 ppm. That is, because the impurity concentration of the first conductivity type contained in the third compound semiconductor layer is extremely low, the third compound semiconductor layer can be regarded as a so-called i-type semiconductor (or an undoped semiconductor). In the optical phase modulator 100 according to the second embodiment, because the first optical waveguide 10 has a layer configuration similar to that of the PIN type diode structure, it is possible to drive the optical phase modulator 100 by applying a reverse bias to the first optical waveguide 10.

### Third Embodiment: Optical Circuit

An optical circuit according to the third embodiment includes any one or more of the optical phase modulators 100, 101, 102, and 103 described in the first and second embodiments, and a second optical waveguide that optically couples with the optical phase modulator.

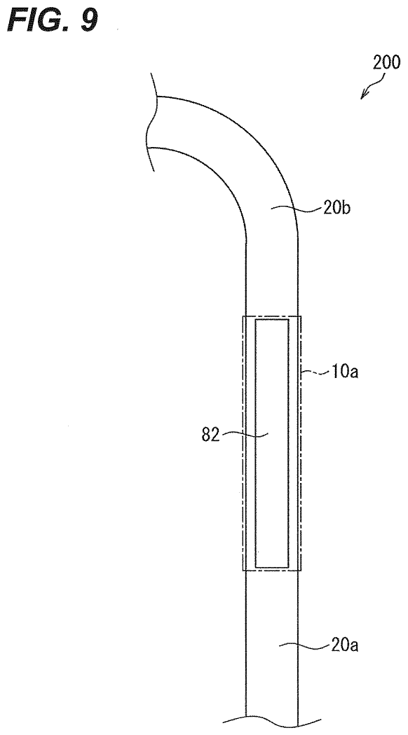

FIGS. 1 and 9 are schematic top views of an optical circuit 200 using an optical phase modulator including a linear waveguide 10a. An end of a linear second optical waveguide 20a is connected to one end of the linear waveguide 10a, and an end of a second optical waveguide 20b having a curved portion is connected to the other end of the linear waveguide 10a. In FIG. 9, the second electrode 82 of the optical phase modulator is omitted.

The optical phase modulator and the second optical waveguides 20a and 20b are optically coupled by directly connecting their ends to each other. Note that the linear waveguide 10a and the second optical waveguides 20a and 20b may be an integrated optical waveguide.

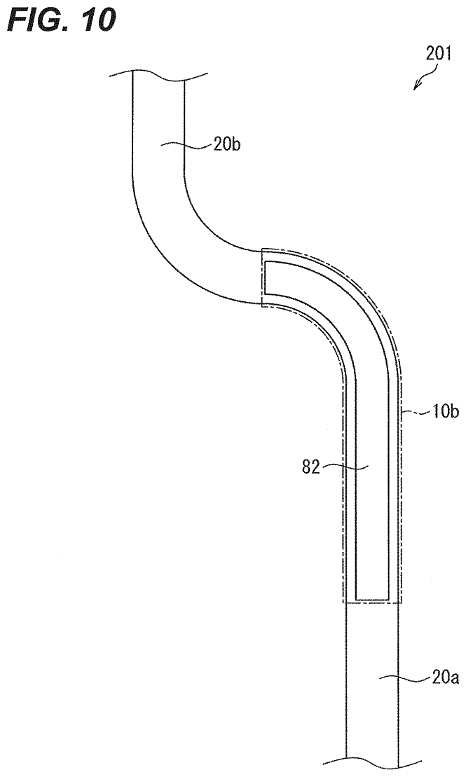

FIG. 10 is a schematic top view of an optical circuit 201 using an optical phase modulator including a bending waveguide 10b. An end of the linear second optical waveguide 20a is connected to one end of the bending waveguide 10b, and an end of the second optical waveguide 20b having a curved portion is connected to the other end of the linear waveguide 10a. In FIG. 10, the second electrode of the optical phase modulator is omitted.

The optical phase modulator and the second optical waveguides 20a and 20b are optically coupled by directly connecting their ends to each other. The bending waveguide 10b and the second optical waveguides 20a and 20b may be an integrated optical waveguide.

In the optical circuits 200 and 201, it is preferable that the second optical waveguides 20a and 20b have the same layer configuration as the first optical waveguide 10 described in the first and second embodiments. The first optical waveguide 10 and the second optical waveguides 20a and 20b can simultaneously be manufactured as a monolithic optical waveguide. This can make it possible to improve optical coupling therebetween. For example, when the semiconductor layers are collectively etched by dry etching, the first optical waveguide 10 and the second optical waveguides 20a and 20b are formed as a monolithic optical waveguide. However, the second optical waveguides 20a and 20b do not include an electrode on the upper surface, and do not have an optical phase modulation function. The distinction between the first optical waveguide 10 and the second optical waveguides 20a and 20b is determined by the presence or absence of the second electrode 82.

According to the configurations of the optical circuits 200 and 201, the second optical waveguide that is optically coupled to the linear waveguide 10a may be an entirely linear second optical waveguide 20a or an entirely curved second optical waveguide 20b.

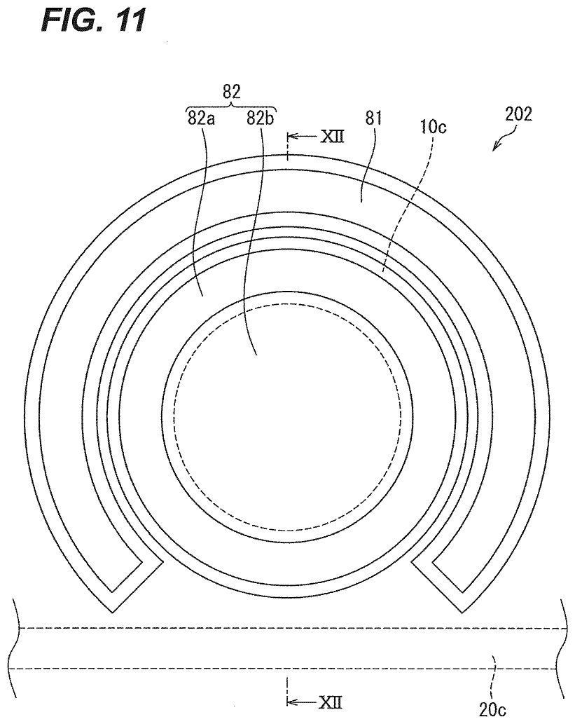

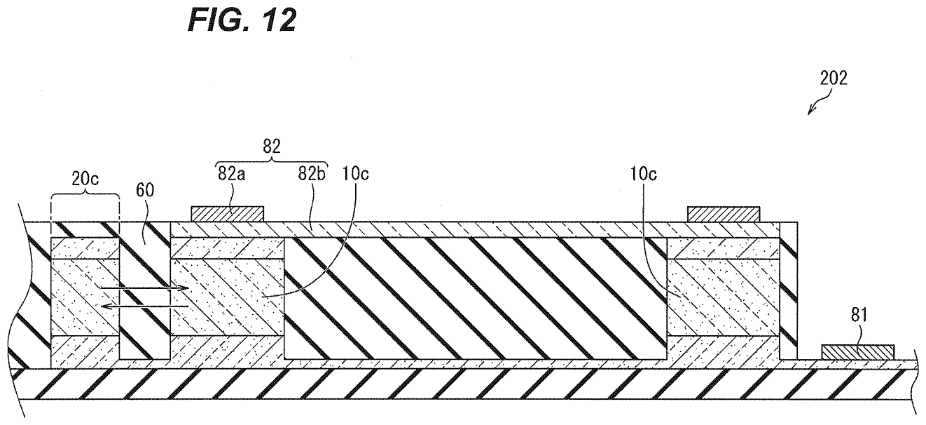

FIG. 11 is a schematic top view of the optical circuit 202 using the optical phase modulator including the ring resonator 10c, and FIG. 12 is a schematic cross-sectional view taken along line XII-XII of FIG. 11.

In the optical circuit 202, the linear second optical waveguide 20c is disposed close to the ring resonator 10c. The ring resonator 10c and the second optical waveguide 20c are not in direct contact with each other, but are sufficiently close to each other, so that they are optically coupled by an evanescent wave of light passing through the ring resonator 10c and the second optical waveguide 20c.

The second optical waveguide 20c may or may not have the same layer configuration as the first optical waveguide 10 described in the first and second embodiments. In the case of having the same layer configuration, the first optical waveguide 10 and the second optical waveguide 20c can be manufactured simultaneously. However, the second optical waveguide 20c does not include an electrode on the upper surface, and does not have the optical phase modulation function.

The second optical waveguide 20c may be partially curved according to the configuration of the optical circuit 202.

The optical circuits 200, 201, and 202 thus configured are suitable for being incorporated in a Mach-Zehnder interferometer.

### Fourth Embodiment: Mach-Zehnder Interferometer

A Mach-Zehnder interferometer according to a fourth embodiment includes any one or more of the optical circuits 200, 201, and 202 described in the third embodiment, a third optical waveguide disposed in parallel with the optical circuit, an input port for receiving light, and an output port for outputting light.

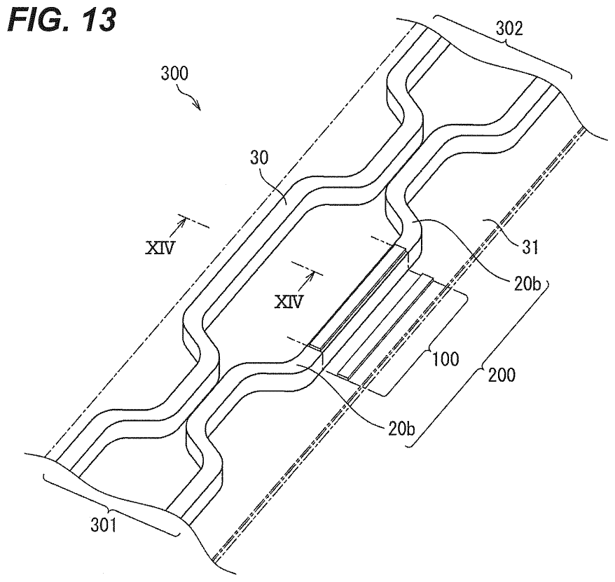

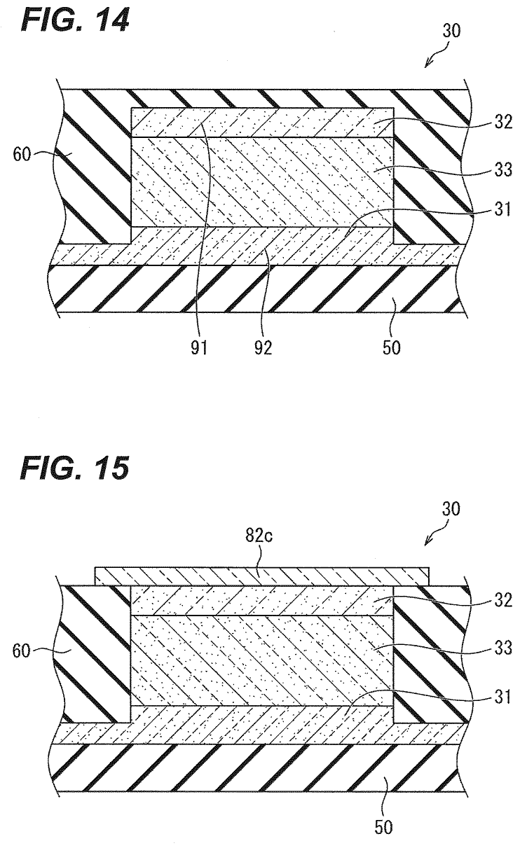

FIG. 13 is a schematic perspective view of a Mach-Zehnder interferometer 300, FIG. 14 is a schematic cross-sectional view illustrating an example of the third optical waveguide taken along line XIV-XIV in FIG. 13, and FIG. 15 is a schematic cross-sectional view illustrating another example of the third optical waveguide.

The Mach-Zehnder interferometer 300 illustrated in FIG. 13 includes the optical circuit 200 including an optical phase modulator 100 and a second optical waveguide 20b, and a third optical waveguide 30 disposed in parallel with the optical circuit 200. The layer configuration and the shape dimension in top view of the optical phase modulator 100 (that is, the linear waveguide 10a, the first electrode 81, and the second electrode 82) and two second optical waveguides 20b constituting the optical circuit 200 are made the same as the layer configuration and the shape dimension in top view of the third optical waveguide 30. As a result, in a state where no voltage is applied to the optical phase modulator 100 of the optical circuit 200, the difference between the phase of the light passing through the third optical waveguide 30 and the phase of the light passing through the optical circuit 200 can be reduced.

For example, the layer configuration of the third optical waveguide 30 illustrated in FIG. 14 is configured by stacking a first cladding layer 31, a core layer 33 disposed above the first cladding layer 31, and a second cladding layer 32 disposed above the core layer 33. The first cladding layer 31, the core layer 33, and the second cladding layer 32 of the third optical waveguide 30 have the same composition and the same layer thickness as those of the first cladding layer 11, the core layer 13, and the second cladding layer 12 of the first optical waveguide 10 of the optical phase modulator 100 included in the optical circuit 200. Note that the example of the third optical waveguide 30 illustrated in FIG. 14 has the same layer configuration as the first optical waveguide 10 of the optical phase modulator 101 illustrated in FIG. 2, and the second cladding layer 32 includes a first composition gradient layer 91.

Because the third optical waveguide 30 does not perform optical phase modulation, an electrode is not required. Therefore, in the example of the third optical waveguide 30 illustrated in FIG. 14, because it is not necessary to expose the upper surface of the second cladding layer 32 from the insulating layer 60, the upper surface of the second cladding layer 32 is covered with the insulating layer 60.

It is preferred that a part (for example, only the light-transmissive conductive film 82b) or the whole of the second electrode 82 is formed in the third optical waveguide 30 to bring the optical confinement characteristic of the third optical waveguide 30 close to the optical confinement characteristic of the optical phase modulator 100. In the example illustrated in FIG. 15, the upper surface of the second cladding layer 32 of the third optical waveguide 30 is covered with a light-transmissive conductive film 82c. To prevent a voltage from being applied to the third optical waveguide 30 via the light-transmissive conductive film 82c, the light-transmissive conductive film 82c needs to be disposed so as to be electrically insulated from the first electrode 81 and the second electrode 82 of the optical phase modulator 100.

The light input from one port of the input port 301 to the Mach-Zehnder interferometer 300 branches into the third optical waveguide 30 and the optical circuit 200, passes through each of them, and then is output from the output port 302.

When a voltage is applied to the optical phase modulator 100 of the optical circuit 200, the refractive index of the first optical waveguide 10 of the optical phase modulator 100 changes, and the relative phase between the light passing through the optical circuit 200 and the light passing through the third optical waveguide 30 changes. When light output from the output port 302 is caused to interfere with each other, interference is weakened due to a phase shift thereof. The amount of change in the relative phase depends on the voltage applied to the optical phase modulator 100. By changing the voltage, the intensity ratio of the light after interference changes.

### Fifth Embodiment: Optical Accelerator

An optical accelerator according to a fifth embodiment includes the Mach-Zehnder interferometer 300 described in the fourth embodiment, a light source that inputs light to the input port 301 of the Mach-Zehnder interferometer 300, and a light receiving element that receives light output from the output port 302 of the Mach-Zehnder interferometer 300.

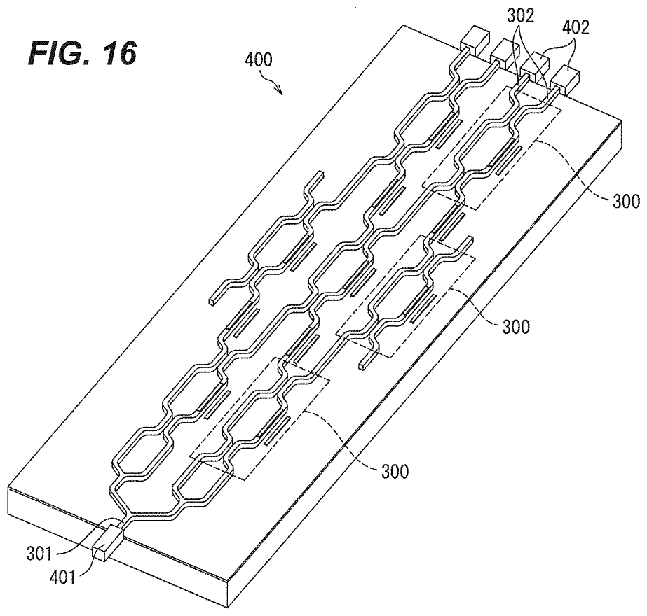

FIG. 16 is a schematic perspective view of an optical accelerator 400, in which a plurality of Mach-Zehnder interferometers 300 are connected in multiple stages (in parallel and in series). A light source 401 is connected to the input port 301 of the most upstream Mach-Zehnder interferometer 300. The light source 401 may be, for example, a semiconductor laser element, a fiber laser, or the like. The light emitted from the light source 401 is input from the input port 301 and branches into an optical circuit of the Mach-Zehnder interferometer 300 and a third optical waveguide. The light that has branched and passed through the branch to each of the optical circuit and the third optical waveguide is guided while interfering in the Mach-Zehnder interferometer 300 and reaches the output port 302. The interference state is detected by the light receiving element 402 disposed in the output port 302.

Note that the input port 301 can be optically coupled to the Mach-Zehnder interferometer 300 by branching with various optical waveguides such as a Y-shaped branching waveguide, an X-shaped branching waveguide, a directional coupler, or a multimode interferometer, for example. In addition, the light input to the light receiving element 402 can be received by an arbitrary port according to the phase relationship in the Mach-Zehnder interferometer 300, or an intensity difference can be given to the light output to each port. By using this, an optical accelerator that is an arithmetic circuit using light can be formed.

### Reference Example

In the reference example, a semiconductor multilayer structure including an undoped layer was fabricated, and it was confirmed that the carrier density of the undoped layer can be determined from the C-V characteristics. Note that the layer structure of the semiconductor multilayer structure fabricated in the reference example differed in part from the layer structure of the optical phase modulator according to the embodiment.

A semiconductor multilayer structure having the following layer structure was fabricated by MOCVD. The semiconductor multilayer structure had, on a sapphire substrate, a first cladding layer including n-type GaN, a core layer including undoped GaN, and a second cladding layer including a first composition gradient layer in which the Al composition of AlGaN was gradated. The composition of the first composition gradient layer was varied such that the bandgap energy decreased in a first direction away from the core layer toward the second cladding layer, by changing the Al composition ratio from 20% to 0%. The thicknesses of the first cladding layer, the core layer, and the second cladding layer were 300 nm, 700 nm, and 200 nm, respectively. A first electrode containing Ti and Pt was connected to the first cladding layer. A pad electrode formed of Cr and Au was formed on the upper surface of the first electrode. A second electrode included a light-transmissive conductive film and a metal electrode was formed. The light-transmissive conductive film was formed of ITO connected to the second cladding layer. The metal electrode was formed of Cr and Au, and was formed on the upper surface of the light-transmissive conductive film.

### C-V Measurement

To facilitate C-V measurement, a mesa structure with a diameter of 220 μm was formed. The mesa structure was obtained by etching the semiconductor multilayer structure from the second cladding layer so as to include the first cladding layer. C-V measurements were performed on the fabricated mesa structure. The bias was varied from 5 V to −20 V at a frequency of 1 MHz. From the slope of the C⁻²-V characteristic, the carrier density of the core layer was determined to be 3.2×10¹⁵ cm⁻³, confirming that the core layer had a carrier density low enough to be regarded as a substantially i-type semiconductor.

What is claimed is:

1. An optical phase modulator comprising:
a first optical waveguide comprising:
a first cladding layer,
a core layer disposed above the first cladding layer, and
a second cladding layer disposed above the core layer;
a first electrode electrically connected to the first cladding layer; and
a second electrode electrically connected to the second cladding layer, wherein:
the first cladding layer comprises a first compound semiconductor layer of a first conductivity type,
the second cladding layer comprises a second compound semiconductor layer of a second conductivity type,
the core layer comprises a third compound semiconductor layer having a carrier density determined from a C-V characteristic of 1×10¹⁷ cm⁻³ or less, and
at least one of the first compound semiconductor layer and the second compound semiconductor layer comprises a composition gradient layer.

2. The optical phase modulator according to claim 1, wherein:
the first conductivity type is n-type,
the second conductivity type is p-type,
the second compound semiconductor layer comprises a first composition gradient layer, and
in the first composition gradient layer, a composition of the second compound semiconductor layer is gradated such that band gap energy decreases in a first direction toward the second cladding layer with respect to the core layer.

3. The optical phase modulator according to claim 2, wherein
the first compound semiconductor layer contains AlₓGa₁₋ₓN (0≤x<1) containing an n-type impurity,
the second compound semiconductor layer contains Al_{y}Ga_{1-y}N (0≤y<1),
the third compound semiconductor layer contains Al_{z}Ga_{1-z}N (0≤z<1, z≤x, z≤y), and
in the first composition gradient layer, an Al composition ratio y of the second compound semiconductor layer decreases in the first direction.

4. The optical phase modulator according to claim 3, further comprising a sapphire substrate disposed below the first cladding layer.

5. The optical phase modulator according to claim 2, wherein:
the first compound semiconductor layer comprises a second composition gradient layer, and
in the second composition gradient layer, a composition of the first compound semiconductor layer is gradated such that band gap energy decreases in a second direction toward the first cladding layer with respect to the core layer.

6. The optical phase modulator according to claim 3, wherein the first composition gradient layer has a thickness of 10 nm or more and 500 nm or less, and an Al composition ratio y of the second compound semiconductor layer decreases at a rate of 0.001 or more and 0.02 or less per 1 nm in the first direction.

7. The optical phase modulator according to claim 1, wherein a thickness of the core layer is 0.5 times or more and 5 times or less a thickness of the first cladding layer and a thickness of the second cladding layer.

8. The optical phase modulator according to claim 1, wherein:
the first optical waveguide comprises a ridge comprising the first cladding layer, the core layer, and the second cladding layer, and
a lower end of a lateral surface of the ridge is located below an interface between the core layer and the first cladding layer.

9. The optical phase modulator according to claim 1, further comprising an insulating layer covering a lateral surface of the first cladding layer, a lateral surface of the core layer, and a lateral surface of the second cladding layer.

10. The optical phase modulator according to claim 1, wherein the first optical waveguide is at least one selected from the group consisting of a linear waveguide, a bending waveguide, and a ring resonator.

11. The optical phase modulator according to claim 10, wherein:
the first optical waveguide comprises at least one selected from the group consisting of the bending waveguide and the ring resonator, and
a bending radius of the first optical waveguide is 50 μm or more and 500 μm or less.

12. An optical phase modulator comprising:
a first optical waveguide comprising:
a first cladding layer,
a core layer disposed above the first cladding layer, and
a second cladding layer disposed above the core layer;
a first electrode electrically connected to the first cladding layer; and
a second electrode electrically connected to the second cladding layer, wherein:
the first cladding layer comprises a first compound semiconductor layer of a first conductivity type,
the second cladding layer comprises a second compound semiconductor layer of a second conductivity type,
the core layer comprises a third compound semiconductor layer,
at least one of the first compound semiconductor layer and the second compound semiconductor layer comprises a composition gradient layer, and
a concentration of a first conductive impurity in the third compound semiconductor layer is lower than a concentration of the first conductive impurity in the first compound semiconductor layer.

13. The optical phase modulator according to claim 7, wherein a concentration of the first conductivity impurity contained in the third compound semiconductor layer is equal to or less than a detection limit value in analysis by energy dispersive X-ray spectroscopy in a region comprising an interface between the first compound semiconductor layer and the third compound semiconductor layer.

14. The optical phase modulator according to claim 12, wherein a thickness of the core layer is 0.5 times or more and 5 times or less a thickness of the first cladding layer and a thickness of the second cladding layer.

15. The optical phase modulator according to claim 12, wherein:
the first optical waveguide comprises a ridge comprising the first cladding layer, the core layer, and the second cladding layer, and
a lower end of a lateral surface of the ridge is located below an interface between the core layer and the first cladding layer.

16. The optical phase modulator according to claim 12, further comprising an insulating layer covering a lateral surface of the first cladding layer, a lateral surface of the core layer, and a lateral surface of the second cladding layer.

17. The optical phase modulator according to claim 12, wherein the first optical waveguide is at least one selected from the group consisting of a linear waveguide, a bending waveguide, and a ring resonator.

18. An optical circuit comprising:
the optical phase modulator according to claim 1; and
a second optical waveguide configured to optically couple with the optical phase modulator.

19. A Mach-Zehnder interferometer comprising:
the optical circuit according to claim 18;
a third optical waveguide disposed in parallel with the optical circuit;
an input port configured to receive light; and
an output port configured to output the light.

20. An optical accelerator comprising:
the Mach-Zehnder interferometer according to claim 19;
a light source configured to input light to the input port of the Mach-Zehnder interferometer; and
a light receiving element configured to receive light output from the output port of the Mach-Zehnder interferometer.
